(19) United States
(12) Patent Application Publication
(10) Pub. No.: US 2002/0103315 A1
(43) Pub. Date: Aug. 1, 2002

(54) Catalyst composition for the polymerization of olefins

(76) Inventor: Thomas H. Peterson, Charleston, WV (US)

Correspondence Address: UNIVATION TECHNOLOGIES LLC, 5555 SAN FELIPE SUITE 1950, HOUSTON, TX, 77056, US

(21) Appl. No.: 10/040,686

(22) Filed: Nov. 7, 2001

Related U.S. Application Data
(63) Continuation of application No. 09/396,266, filed on Sep. 15, 1999.
Application No. 09/396,266 is a continuation-in-part of application No. 09/154,459, filed on Sep. 16, 1998.

(51) Int. Cl. C08F 4/44

(52) U.S. Cl. 526/160; 526/161; 526/943; 502/103; 502/152

(57) ABSTRACT

A catalyst composition for the polymerization of olefins is provided. The catalyst composition comprises a monocycloalkadienyl/metal/ligand catalyst precursor, wherein at least one ligand is capable of multihapto attachment to the metal atom through a carbon or hydrogen atom, and a cocatalyst capable of irreversibly abstracting a ligand from the catalyst precursor.

### STATEMENT OF RELATED APPLICATIONS

The present application is a continuation of U.S. Application Ser. No. 09/396,266, filed Sep. 15, 1999, which is a continuation-in-part of U.S. Application Ser. No. 09/154,459, filed Sep. 16, 1998.

### FIELD OF THE INVENTION

The present invention relates to a catalyst composition useful for the polymerization of olefins. The catalyst composition preferably comprises a monocycloalkadienyl/metal/ligand catalyst precursor, preferably wherein at least one ligand is capable of multihapto attachment to the metal through a carbon or hydrogen atom, and an activator.

### BACKGROUND OF THE INVENTION

A variety of catalyst compositions containing single site catalyst precursors have been shown to be highly useful in the preparation of polyolefins, producing relatively homogeneous copolymers at good polymerization rates and allowing one to tailor the properties of the finished polymer closely. In contrast to traditional Ziegler-Natta catalyst compositions, single site catalyst compositions comprise catalytic compounds in which each catalyst composition molecule contains one or only a few polymerization sites.

The most well known category of single site catalyst precursors is metallocenes of the general formula Cp₂MX₂ wherein Cp is a cycloalkadienyl ligand, typically cyclopentadienyl or indenyl, M is a metal, usually from Group 4, and X is a halogen or alkyl group. However, recently single site catalyst precursors containing a combination of cycloalkadienyl and multihapto ligands bound to a metal atom have been described. For example, U.S. Pat. No. 5,527,752 describes a broad class of monocycloalkadienyl catalyst precursors that are complexes of a transition metal, a substituted or unsubstituted cycloalkadienyl ligand, and one or more heteroallyl moieties. These precursors may be activated with aluminoxanes or boron compounds.

Pellecchia et al., Makromol. Chem., Rapid Commun., 12:663 (1991) relates to the polymerization behavior of organometallic compounds of Group 4 metals. In particular, CpZrBz₃, wherein Bz is a benzyl group, activated with methylaluminoxane (MAO) or N,N-dimethylanilinium tetrakis(pentafluorophenyl)borate (AFPB) was used by the authors to polymerize ethylene. Based on the data given in Table 1, the catalyst composition containing MAO as the activator was considerably more active than the catalyst composition containing AFPB. Pellecchia et al., Macromol. Symp.,89:335 (1995) discloses that only unstable and unisolable compositions are obtained from the reaction of CpZrBz₃ and [HNR₃]+[B(C₆F₅)₄]− or [CPh3]+[B(C6F5)4]−.

The present invention revolves around the discovery that single site catalyst precursors comprising at least one ligand capable of multihapto attachment to the metal atom through carbon and/or hydrogen atoms combined with a activator capable of irreversibly abstracting a ligand (multihapto or other) from the catalyst precursor are particularly effective for the polymerization of olefins. Contrary to the teachings of Pellecchia et al., such catalyst compositions are indeed stable. This unique combination of catalyst precursor and activator provides an extremely active catalyst composition.

Metallocene polymerization catalysts have recently been used to produce resins having a desirable product properties. For example metallocene catalysts have been used by Exxon Chemical Company to produce Exceed™ type polyethylene resins. However finding a metallocene polymerization catalyst that produces a desired polymer and has good activity can be very difficult. Activity is measure of how quickly a catalyst can turn raw materials into a chemical product. Having catalysts of high activity is advantageous in that it allows for high throughput through manufacturing equipment and therefore lowers the cost of production of the polymer.

In the metallocene area finding the right combination of activity and product properties can be difficult. Thus there is a need in the art to provide new catalyst systems that can produce polymer products with desirable properties at commercially acceptable activities.

This invention provides catalyst systems for the polymerization of olefins comprising an activator and a monocycloalkadienyl transition metal compound that have good activities and produce polymers having good physical properties.

Others have looked into monocyclopentadienyl transition metal catalysts. For Example, Dow Chemical Company is believed to catalyze the ELITE™ and ENGAGE™ polymer products with bridged monocyclopentadienyl transition metal compounds.

Others who have investigated monocyclopentadienyl transition metal compounds include:

1. Chen, Y. -X.; Fu, P. -F.; Stern, C. L.; Marks, T. J. Organometal. 1997, 16, 5958-5963, who disclose phenoxides tethered to the Cp ring activated with BArF and B(C₆F₅)₃.

2. Ewart, S. W.; Sarsfield, M. J.; Dusan, J.; Tremblay, T. L.; Williams, E. F.; Baird, M. C. Organometal. 1998, 17, 1502-1510, who disclose Cp*TiMe₂L (L=Me, Cl, C₆F₅, OC₆F₅) activated with B(C₆F₅)₃.

3. Nomura, K.; Naga, N.; Miki, M.; Yanagi, K.; Imai, A. Organometal. 1998, 17, 2152-2154, who disclose Cp*Ti(OAr)X₂ and polymerize C₂ and C₂/C₄ by activation with MAO or TIBA/Trifaba.

4. Nomura, K.; Naga, N.; Miki, M.; Yanagi, K. Macromolecules 1998, 31, 7588-7597 who disclose preparation of LTi(OAr)Me₂ (L=Cp and substituted Cp's; OAr=substituted phenols) complexes and their activation with activators for polymerization studies.

5. Sarsfield, M. J.; Ewart, S. W.; Tremblay, T. L.; Roszak, A. W.; Baird, M. C. J. Chem. Soc., Dalton Trans. 1997, 3097-3104 who disclose preparation of and ionization properties of Cp*TiMe₂(L) (L=Me, OC₆F₄, C₆F₅) with B(C₆F₅)₃

### SUMMARY OF THE INVENTION

In one embodiment, the invention provides a catalyst composition for the polymerization of olefins comprising: a) a catalyst precursor of the formula LMⁿ⁺(X)_{y}(R)_{(n-y-1)}, wherein L is a cycloalkadienyl ligand but not cyclopentadienyl or pentamethylcyclopentadienyl; M is an element selected from Groups 3 to 10 and the Lanthanides; each X is independently an anion; each R is a hydride or a group containing at least two carbons capable of attachment to M in a multihapto manner through at least one hydrogen or carbon atom; n is the oxidation state of M; and y is an integer from 0 to 5; and b) an activator, preferably an activator capable of irreversibly abstracting an X or an R from the catalyst precursor such that at least one metal-carbon or metal-hydrogen bond is retained in the resulting activated catalyst.

This invention also provides a catalyst composition for the polymerization of olefins comprising: a) a catalyst precursor of the formula CpD^{a}(JY) (Q)₍ₐ₋₂₎, wherein Cp is a cycloalkadienyl ligand, preferably a cyclopentadienyl ligand, preferably a substituted or unsubstituted cyclopentadienyl or a related cycloalkadienyl congener, D is group 4, 5 or 6 metal provided however that when Cp is a mono-cyclic cyclopentadienyl group, D is not titanium,

a is the oxidation state of D, preferably 3, 4 or 5,

J is a group 15, 16 or 17 atom,

Y is a heteroatom, a substituted heteroatom or a C₁ to C₁₀₀ hydrocarbyl group which may optionally contain one or more heteroatoms,

each Q is independently an anionic leaving group; and

b) an activator.

The invention also provides processes for preparing cycloalkadienyl/metal catalyst precursors, and a process for the polymerization of olefins, which comprises contacting olefins under polymerization conditions with the above catalyst compositions.

### DETAILED DESCRIPTION OF THE INVENTION

Olefin polymers that may be produced according to the invention include, but are not limited to, ethylene homopolymers, homopolymers of linear or branched alpha-olefins containing 3 to about 20 carbon atoms, and interpolymers of ethylene and such higher alpha-olefins, with densities ranging from about 0.86 to about 0.96 g/cm³. Suitable alpha-olefins include, for example, propylene, 1-butene, 1-pentene, 1-hexene, 4-methyl-1-pentene, 1-octene, and 3,5,5-trimethyl-1-hexene. Olefin polymers according to the invention may also be based on or contain conjugated or non-conjugated dienes, such as linear, branched, or cyclic hydrocarbon dienes having from about 4 to about 20, preferably 4 to 12, carbon atoms. Preferred dienes include 1,4-pentadiene, 1,5-hexadiene, 5-vinyl-2-norbornene, 1,7-octadiene, vinyl cyclohexene, dicyclopentadiene, butadiene, isobutylene, isoprene, ethylidene norbornene, norbornadiene and the like. Aromatic compounds having vinyl unsaturation such as styrene and substituted styrenes, and polar vinyl monomers such as acrylonitrile, maleic acid esters, vinyl acetate, acrylate esters, methacrylate esters, vinyl trialkyl silanes and the like may be polymerized according to the invention as well. Specific olefin polymers that may be made according to the invention include, for example, polyethylene, polypropylene, ethylene/propylene rubbers (EPR's), ethylene/propylene/diene terpolymers (EPDM's), polybutadiene, polyisoprene and the like.

In a preferred embodiment, the catalyst composition comprises a catalyst precursor of the formula LMⁿ⁺(X)y(R)_{(n-y-1)}. L is any cycloalkadienyl ligand except for cyclopentadienyl and pentamethylcyclopentadienyl. L may be for example methylcyclopentadienyl, 1,2-dimethylcyclopentadienyl, 1,3-dimethylcyclopentadienyl, 2,3,4,5-tetramethylcyclopentadienyl, trimethylsilylcyclopentadienyl, or phenylcyclopentadienyl. L may also be any unsubstituted or substituted indenyl or fluorenyl ligand such as indenyl, fluorenyl, trimethylsilylindenyl, 2-methylindenyl, 2-arylindenyl, or trimethylsilylfluorenyl. Preferably, L is selected from methylcyclopentadienyl, 1,3-dimethylcyclopentadienyl, indenyl, fluorenyl, and 2-arylindenyl. More preferably, L is selected from methylcyclopentadienyl, 1,3-dimethylcyclopentadienyl, indenyl, and fluorenyl. Most preferably, L is methylcyclopentadienyl.

M is an element selected from Groups 3 to 10 and the Lanthanides. Preferably, M is selected from Groups 3, 4, 5, 6 and the Lanthanides. More preferably, M is a Group 4 element. Zirconium is particularly preferred.

Each X is an anion. Preferably, each X is selected from hydrogen, or unsubstituted or substituted aryl, alkyl, alkenyl, alkylaryl, or arylalkyl radicals having 1-20 carbon atoms. Alternatively, X may be a group of atoms or a single atom bound to M via an atom selected from the halides, chalcogenides and pnictides. More preferably, each X is selected from arylalkyl, alkoxy, aryloxy, alkylamido, arylamido, or halide. Most preferably, X is benzyl.

Each R is independently a hydride or a group containing at least two carbons capable of attachment to M in a multihapto manner through at least one hydrogen or carbon atom. For purposes of the invention, “capable of multihapto attachment” means that the R group possesses at least one mode of bonding in which more than one atom is capable of creating a stabilizing interaction through electron donation to the metal center. Examples of R include benzyl, methylnaphthyl, allyl, crotyl, and cinnamyl. Preferably, R is benzyl, methylnaphthyl, allyl, or crotyl. More preferably, R is benzyl or allyl. Most preferably, R is benzyl.

n is the valence of M.

y is an integer from 0 to 5.

In another embodiment the catalyst precursor is represented by the formula:

CpD^{a}(JY)(Q)₍ₐ₋₂₎,

wherein

Cp is a cycloalkadienyl, preferably a cyclopentadienyl ligand, preferably a substituted or unsubstituted cyclopentadienyl or a related cycloalkadienyl congener,

D is group 4, 5 or 6 metal, preferably a group 4 metal, preferably zirconium or hafnium provided however that when Cp is a mono-cyclic cyclopentadienyl group, D is not titanium

a is the oxidation state of D, preferably 3, 4 or 5, preferably 4,

J is a group 15, 16 or 17 atom,

Y is a heteroatom, a substituted heteroatom or a C₁ to C₁₀₀ hydrocarbyl group which may optionally contain one or more heteroatoms, and

each Q is independently an anionic leaving group.

In a preferred embodiment Cp is a cyclopentadienyl group substituted with up to five substituents (not including the metal D), which may be the same or different, selected from the group consisting of heteroatoms (preferably group 13 to group 17 heteroatoms) or heteroatom containing groups, hydrocarbyl groups, (such as C₁ to C₄₀ alkyl, alknyl, aryl, arylalkyl groups, or C₁ to C₁₀₀ linear, branched or cyclic aryl, alkyl, alkenyl or alkynyl groups), the substituents may join together forming C₄-C₂₀ ring(s) to give a saturated or unsaturated polycyclic cyclopentadienyl ligand such as indenyl, tetrahydroindenyl, fluorenyl or octahydrofluorenyl; preferred substituents for the Cp group include methyl, ethyl, propyl, butyl, pentyl, hexyl, cyclopentyl, cyclohexyl, benzyl or phenyl groups and the like, including all their isomers, for example tertiary butyl, iso propyl etc. Preferred non-hydrogen substituents include the atoms carbon, silicon, nitrogen, oxygen, tin, germanium and the like including olefins.

In a particularly preferred embodiment the Cp group is a substituted or unsubstituted indenyl group. The indenyl is preferably substituted with up to 7 substituents (not including the metal D), which may be the same or different, selected from the group consisting of heteroatoms (preferably group 13 to group 17 heteroatoms) or heteroatom containing groups, hydrocarbyl groups, (such as C₁ to C₄₀ alkyl, alknyl, aryl, arylalkyl groups, or C₁ to C₁₀₀ linear, branched or cyclic aryl, alkyl, alkenyl or alkynyl groups). Preferred substituents include methyl, ethyl, propyl, butyl, pentyl, hexyl, cyclopentyl, cyclohexyl, benzyl or phenyl or substituted phenyl or other substituted and unsubstituted aryl groups and the like, including all their isomers, for example tertiary butyl, iso-propyl etc. Preferred non-hydrogen substituents include the atoms carbon, silicon, nitrogen, oxygen, tin, germanium and the like including olefins. In a particularly preferred embodiment of the invention, the Cp group is an unsubstituted indene group.

In another particularly preferred embodiment the Cp group is a substituted or unsubstituted fluorenyl group. The fluorenyl is preferably substituted with up to nine substituents (not including the metal D), which may be the same or different, selected from the group consisting of heteroatoms (preferably group 13 to group 17 heteroatoms) or heteroatom containing groups, hydrocarbyl groups, (such as C₁ to C₄₀ alkyl, alknyl, aryl, arylalkyl groups, or C₁ to C₁₀₀ linear, branched or cyclic aryl, alkyl, alkenyl or alkynyl groups). Preferred substituents include methyl, ethyl, propyl, butyl, pentyl, hexyl, cyclopentyl, cyclohexyl, benzyl or phenyl or substituted phenyl or other substituted and unsubstituted aryl groups and the like, including all their isomers, for example tertiary butyl, iso propyl etc. Preferred non-hydrogen substituents include the atoms carbon, silicon, nitrogen, oxygen, tin, germanium and the like including olefins.

In a preferred embodiment each Q is, independently any univalent anionic ligand such as halogen, hydride, or substituted or unsubstituted C₁-C₃₀ hydrocarbyl, alkoxide, aryloxide, amide or phosphide, provided that two Q may be an alkylidene, a cyclometallated hydrocarbyl or any other divalent anionic chelating ligand. In a more preferred embodiment of the invention, each Q may be independently a substituted or unsubstituted multihapto anionic hydrocarbyl ligand such as allyl or benzyl and substituted versions thereof such as crotyl, prenyl and neophyl. Additionally, Q may be a multihapto monoanionic ligand containing heteroatoms such as aluminum or boron wherein the heteroatoms comprise bridges between two or more hydrogen or non-hydrogen atoms such as is exemplified in borohydride or aluminum hydride groups bonding with transition metals. In a particularly preferred embodiment of the invention, Q is benzyl or phenyl.

In a preferred embodiment J is nitrogen, oxygen, sulfur, phosphorus, chlorine, fluorine or bromine, preferably oxygen nitrogen or sulfur. In a particularly preferred embodiment J is oxygen.

In a preferred embodiment Y is a group 13-17 heteroatom, a substituted group 13-17 heteroatom group, a C₁ to C₁₀₀ linear, branched or cyclic aryl, alkyl, alkenyl or alkynyl group, or a C₁ to C₄₀ alkyl, alknyl, aryl, or arylalkyl group, preferably benzyl or phenyl. Preferred Y groups include alkyl and perfluoroalkyl groups such as n-propyl, isopropyl, n-butyl, t-butyl, methylcyclohexyl, methylcyclopentyl, methoxymethyl, ethoxymethyl, aminomethyl and aminoethyl, perfluoropropyl, and perfluorobutyl, cycloalkyl groups such as cyclopentyl, cychexyl and bicyclo[2.2.1]heptyl and aryl groups such as phenyl, methyl phenyl, di methyl phenyl, di n-butylphenyl, di-t-butylphenyl, mesityl, 4-trimethylsilyl, fluorophenyl, perfluorophenyl, methoxyphenyl, dimethylaminophenyl, naphthyl, and anthracenyl.

In another embodiment R and Q may be bound to each other.

In one embodiment D is a group 4 metal, J is oxygen and Y is preferably benzyl or phenyl.

It is contemplated in some embodiments, that the cyclopentadienyl group described above is asymmetrically substituted in terms of additional substituents or types of substituents, and/or unbalanced in terms of the number of additional substituents on the cyclopentadienyl. It is also contemplated that in one embodiment, catalyst precursors of the invention include their structural or optical or enantiomeric isomers and mixtures thereof.

The catalyst precursors described herein are preferably combined with one or more activators to form an olefin polymerization catalyst system. Preferred activators include alkyl aluminum compounds (such as diethylaluminum chloride), alumoxanes, modified alumoxanes, non-coordinating anions, non-coordinating group 13 metal or metalloid anions, boranes, borates and the like or a combination thereof. It is within the scope of this invention to use alumoxane or modified alumoxane as an activator, and/or to also use ionizing activators, neutral or ionic, such as tri (n-butyl) ammonium tetrakis (pentafluorophenyl) boron or a trisperfluorophenyl boron metalloid precursor which ionize the neutral metallocene compound. Other useful compounds include triphenyl boron, triethyl boron, tri-n-butyl ammonium tetraethylborate, triaryl borane and the like. Other useful compounds include aluminate salts as well.

In a preferred embodiment modified alumoxanes are combined with the catalyst precursor compounds to form a catalyst system. In a preferred embodiment MMAO3A (modified methyl alumoxane in heptane, commercially available from Akzo Chemicals, Inc. under the trade name Modified Methylalumoxane type 3A, covered under U.S. Pat. No. 5,041,584) is combined with the metal compounds to form a catalyst system.

In a preferred embodiment the activator is capable of irreversibly abstracting an X or an R in formula I or a Q, Yor a JY in formula II from the catalyst precursor such that at least one metal-carbon or metal-hydrogen bond is retained in the resulting activated catalyst.

There are a variety of methods for preparing alumoxanes and modified alumoxanes, non-limiting examples of which are described in U.S. Pat. Nos. 4,665,208, 4,952,540, 5,091,352, 5,206,199, 5,204,419, 4,874,734, 4,924,018, 4,908,463, 4,968,827, 5,308,815, 5,329,032, 5,248,801, 5,235,081, 5,157,137, 5,103,031, 5,391,793, 5,391,529, 5,041,584 5,693,838, 5,731,253, 5,041,584 and 5,731,451 and European publications EP-A-0 561 476, EP-B1-0 279 586 and EP-A-0 594-218, and PCT publication WO 94/10180, all of which are herein fully incorporated by reference.

Ionizing compounds may contain an active proton, or some other cation associated with but not coordinated to or only loosely coordinated to the remaining ion of the ionizing compound. Such compounds and the like are described in European publications EP-A-0 570 982, EP-A-0 520 732, EP-A-0 495 375, EP-A-0 426 637, EP-A-500 944, EP-A-0 277 003 and EP-A-0 277 004, and U.S. Pat. Nos. 5,153,157, 5,198,401, 5,066,741, 5,206,197, 5,241,025, 5,387,568, 5,384,299, 5,502,124 and 5,643,847, all of which are herein fully incorporated by reference. Other activators include those described in PCT publication WO 98/07515 such as tris (2, 2′, 2″-nonafluorobiphenyl) fluoroaluminate, which is fully incorporated herein by reference. Combinations of activators are also contemplated by the invention, for example, alumoxanes and ionizing activators in combinations, see for example, PCT publications WO 94/07928 and WO 95/14044 and U.S. Pat. Nos. 5,153,157 and 5,453,410 all of which are herein fully incorporated by reference. Also, methods of activation such as using radiation and the like are also contemplated as activators for the purposes of this invention.

In general the metal compounds and the activator are combined in ratios of about 1000:1 to about 0.5:1. In a preferred embodiment the metal compounds and the activator are combined in a ratio of about 300:1 to about 1:1, preferably about 100:1 to about 1:1, for boranes, borates, aluminates, etc. the ratio is preferably about 1:1 to about 10:1 and for alkyl aluminum compounds (such as diethylaluminum chloride combined with water) the ratio is preferably about 0.5:1 to about 10:1.

The catalyst precursors and the activators may be combined, in any order of addition, as two solutions, as a solid and a solution or as two solids, provided the addition of a carrier solvent facilitates eventual contact and reaction. In one embodiment, a solution of the metal compound is added to a solution of the activator with sufficient contacting time to generate the active catalyst. In a preferred embodiment, a catalyst solution is added to a solution of the activator and the two components are allowed to react for a period of at least 25 minutes prior to introduction to the reactor. In a most preferred embodiment, the catalyst and activator are reacted for a period of at least 5 minutes prior to introduction to the reactor.

The catalyst system, the catalyst precursor and or the activator may be introduced into the reactor in solution. In one embodiment a solution of the activated metal compound in an alkane such as pentane, hexane, isopentane or the like is feed into a gas phase or slurry phase reactor. In another embodiment, the catalyst is supported on an inert support or matrix and is fed as a dry powder or a slurried composition to the reactor. One can also prepare a support to which is chemisorbed or physisorbed a functioning activator, which is reacted with the precursor to form the active catalyst and through which the active catalyst is anchored to the support material.

The catalyst precursor may be made by any means, and the invention is not limited thereby. For example, one method of making the catalyst precursor is via metathesis reaction of a homoleptic metal alkyl complex with an alkaline or alkaline earth metal salt of a cycloalkadiene. The reaction may be carried out in a suitable solvent.

Preferably, the homoleptic metal alkyl complex comprises a metal selected from Groups 4, 5, or 6, more preferably from Group 4. Examples of homoleptic metal alkyl complexes include tetrabenzyltitanium, tetrabenzylzirconium, tetrabenzylhafnium, tetrakis(trimethylsilyhnethyl)zirconium, tetrakis(2,2-dimethylpropyl)zirconium, tetramethylzirconium, tetrakis(2-methyl-2-phenylpropyl)zirconium, pentakis(2,2-dimethylpropyl)tantalum, and hexamethyltungsten.

Examples of alkaline metal and alkaline earth metal salts of cycloalkadienyl ligands include cyclopentadienyllithium and its sodium and potassium congeners, indenyllithium and its sodium and potassium congeners, and fluorenyllithium and its sodium and potassium congeners. Other examples of alkaline metal and alkaline earth metal salts of cycloalkadienyl ligands include bis(cyclopentadienyl)magnesium and bis(cyclopentadienyl)calcium. Salts of substituted cycloalkadienyl ligands may be used as well.

For example, the catalyst precursor (methylcyclopentadienyl)tribenzylzirconium may be made by reacting a well-stirred toluene solution of tetrabenzylzirconium at room temperature and ambient pressure with one equivalent of methylcyclopentadienyllithium for a period of 12 hours. The product can then be isolated from the benzyllithium byproduct either by precipitation of benzyllithium by addition of an equivalent volume of hexane or by reacting the benzyllithium with chlorotrimethylsilane followed by filtration from the lithium chloride byproduct. The product can then be recrystallized from a hydrocarbon solvent.

The catalyst precursor can also be prepared by the metathesis reaction of a metal alkyl-borate salt with an alkaline metal or alkaline earth metal salt of a cycloalkadiene. The reaction may optionally be carried out in a suitable solvent.

Examples of metal alkyl-borate salts include tribenzylzirconium-η⁶-(tetraphenylborate) (which can be prepared according to the procedure of Bochmann et al., J. Chem. Soc., Chem. Comm., 1990, 1038-1039) and tribenzylzirconium-[η⁶-benzyl-tris(pentafluorophenyl)-borate] (which can be prepared according to the procedure of Pellecchia et al., J. Mol. Catal. 82, 1993, 57-65).

Examples of alkaline metal and alkaline earth metal salts of cycloalkadienyl ligands are given above.

In one example according to this second method of preparation, a stirred toluene solution of tribenzyizirconium-η⁶-(tetraphenylborate) under an inert atmosphere may be reacted at ambient temperature and pressure with one equivalent of fluorenylpotassium. After stirring for approximately 12 hours, the reaction mixture is filtered to remove potassium tetraphenylborate and fluorenyltribenzylzirconium is isolated by removal of the solvent from the filtrate. The zirconium complex may then be purified by recrystallization from toluene-hexane.

In a third method, the catalyst precursor may be prepared by the metathesis reaction of a cycloalkadiene with a metal alkyl-borate salt. Suitable solvents may again be used.

Examples of metal alkyl-borate salts are described above. Examples of cycloalkadienes include cyclopentadiene, indene, fluorene, trimethylsilylcyclopentadiene, trimethylsilylindene and other substituted congeners thereof.

In one example according to this method, a stirred toluene solution of tribenzylzirconium-[η⁶-benzyl-tris(pentafluorophenyl)borate] under an inert atmosphere is reacted with one equivalent of trimethylsilylindene for a period of 12 hours at ambient temperature and pressure. (1-Trimethylsilylindenyl)dibenzylzirconium-[η⁶-benzyl-tris(pentafluorophenyl)borate] is precipitated as a bright yellow crystalline solid, which may be washed with toluene and dried in vacuo to give the desired complex in pure form.

Aside from preparation of monocycloalkadienyl/metal/ligand catalyst precursors according to the present invention, the above three methods may be used to prepare other cycloalkadienyl/metal complexes useful as catalyst precursors, such as asymmetric bis(cycloalkadienyl) metal complexes typically used as catalyst precursors for polymerizing propylene.

Preferably, the catalyst precursor has the formula:

LMⁿ⁺(CH₂Ph)ₙ₋₁

wherein L, M, and n have the meanings stated above, and Ph is phenyl.

in a particularly preferred embodiment of the invention, the catalyst precursor has one of the formulas:

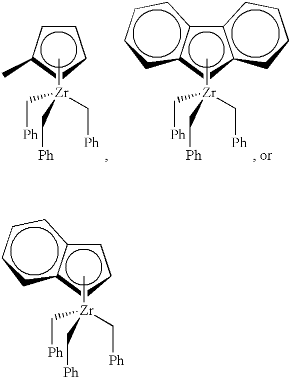

In a preferred embodiment the activator is capable of irreversibly abstracting a ligand, i.e., an X or an R, from the catalyst precursor such that at least one metal-carbon or metal-hydrogen bond remains in the activated catalyst. For purposes of this invention, “irreversible” means that the reaction that takes place between the catalyst precursor and the activator is exothermic so as to render the microscopic reverse of the reaction very improbable. Further, the activator is preferably chosen such that the product of the abstraction/activating step is one that does not interact with the active catalyst site so as to severely limit access of reactive monomers to the active species. In addition, the activator is a compound capable of generating a counterionic partner for the active catalyst composition that also does not interact strongly with the catalytic site so as to hinder the polymerization process.

Activators according to the invention include for example salts, such as carbenium or ammonium salts, of borates and aluminates. Preferably, the activator is a salt comprising a cation selected from triphenylcarbenium, dimethylanilinium, and trialkylammonium and an anion selected from borate and aluminate. More preferably, the activator is a borate of the formula BR″₄_{⁻}, wherein R″ is a strong-electron withdrawing moiety such as perfluoroaryl, perfluoroalkyl or perfluoroalkyl-substituted moieties. Most preferably the activator is triphenylcarbenium tetrakis (pentafluorophenyl)borate.

The activated catalyst composition according to the invention is formed by reacting one of the above activators with a catalyst precursor. For example, (methylcyclopentadienyl)tribenzylzirconium may be reacted with triphenylcarbenium tetrakis(pentafluorophenyl)borate to make an activated catalyst composition as follows:

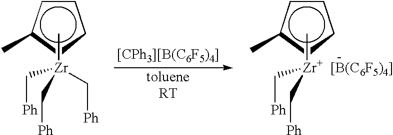

The catalyst composition may be impregnated onto a solid, inert support, in liquid form such as a solution or dispersion, spray dried, in the form of a prepolymer, or formed in-situ during polymerization. Particularly preferred among these is a catalyst composition that is spray dried as described in U.S. Pat. No. 5,648,310 or in liquid form as described in U.S. Pat. No. 5,317,036. For example, the catalyst composition may be introduced into the reaction zone in unsupported, liquid form as described in U.S. Pat. No. 5,317,036. As used herein, “unsupported, liquid form” includes liquid catalyst precursor, liquid activator, solution(s) or dispersions thereof in the same or different solvent(s), and combinations thereof. Unsupported, liquid form catalyst compositions have a number of practical benefits. Unsupported catalyst compositions avoid the costs associated with support material and its preparation, and provide for the realization of a very high catalyst surface -area to volume ratio. Furthermore, unsupported catalyst compositions produce polymers having a much lower residual ash content than polymers produced using supported catalyst compositions.

In the case of a supported catalyst composition, the catalyst composition may be impregnated in or deposited on the surface of an inert substrate such as silica, carbon black, polyethylene, polycarbonate porous crosslinked polystyrene, porous crosslinked polypropylene, alumina, thoria, zirconia, or magnesium halide (e.g., magnesium dichloride), such that the catalyst composition is between 0.1 and 90 percent by weight of the total weight of the catalyst composition and the support.

The catalyst composition may be used for the polymerization of olefins by any suspension, solution, slurry, or gas phase process, using known equipment and reaction conditions, and is not limited to any specific type of reaction system. Generally, olefin polymerization temperatures range from about 0° C. to about 200° C. at atmospheric, subatmospheric, or superatmospheric pressures. Slurry or solution polymerization processes may utilize subatmospheric or superatmospheric pressures and temperatures in the range of about 40° C. to about 110° C. A useful liquid phase polymerization reaction system is described in U.S. Pat. No. 3,324,095. Liquid phase reaction systems generally comprise a reactor vessel to which olefin monomer and catalyst composition are added, and which contains a liquid reaction medium for dissolving or suspending the polyolefin. The liquid reaction medium may consist of the bulk liquid monomer or an inert liquid hydrocarbon that is nonreactive under the polymerization conditions employed. Although such an inert liquid hydrocarbon need not function as a solvent for the catalyst composition or the polymer obtained by the process, it usually serves as solvent for the monomers employed in the polymerization. Among the inert liquid hydrocarbons suitable for this purpose are isopentane, hexane, cyclohexane, heptane, benzene, toluene, and the like. Reactive contact between the olefin monomer and the catalyst composition should be maintained by constant stirring or agitation. The reaction medium containing the olefin polymer product and unreacted olefin monomer is withdrawn from the reactor continuously. The olefin polymer product is separated, and the unreacted olefin monomer and liquid reaction medium are recycled into the reactor.

Preferably, gas phase polymerization is employed, with superatmospheric pressures in the range of 1 to 1000 (6.9 to 6894 kPa), preferably 50 to 400 psi (345 to 2758 kPa), most preferably 100 to 300 psi (690 to 2068 kPa), and temperatures in the range of 30 to 130° C., preferably 65 to 110° C. Stirred or fluidized bed gas phase reaction systems are particularly useful. Generally, a conventional gas phase, fluidized bed process is conducted by passing a stream containing one or more olefin monomers continuously through a fluidized bed reactor under reaction conditions and in the presence of catalyst composition at a velocity sufficient to maintain a bed of solid particles in a suspended condition. A stream containing unreacted monomer is withdrawn from the reactor continuously, compressed, cooled, optionally fully or partially condensed as disclosed in U.S. Pat. Nos. 4,528,790 and 5,462,999, and recycled to the reactor. Product is withdrawn from the reactor and make-up monomer is added to the recycle stream. As desired for temperature control of the system, any gas inert to the catalyst composition and reactants may also be present in the gas stream. In addition, a fluidization aid such as carbon black, silica, clay, or talc may be used, as disclosed in U.S. Pat. No. 4,994,534.

Polymerization may be carried out in a single reactor or in two or more reactors in series, and is conducted substantially in the absence of catalyst poisons. Organometallic compounds may be employed as scavenging agents for poisons to increase the catalyst activity. Examples of scavenging agents are metal alkyls, preferably aluminum alkyls, most preferably triisobutylaluminum.

Conventional adjuvants may be included in the process, provided they do not interfere with the operation of the catalyst composition in forming the desired polyolefin. Hydrogen or a metal or non-metal hydride, e.g., a silyl hydride, may be used as a chain transfer agent in the process. Hydrogen may be used in amounts up to about 10 moles of hydrogen per mole of total monomer feed.

Aluminum alkyls such as trimethylaluminum, triethylaluminum, or triisobutylaluminum may also be added to the process, or to the catalyst composition directly.

A preferred process of the invention is where the process, preferably a slurry or gas phase process is operated in the absence of or essentially free of any scavengers, such as triethylaluminum, trimethylaluminum, tri-isobutylaluminum and tri-n-hexylaluminum and diethyl aluminum chloride, dibutyl zinc and the like. This preferred process is described in PCT publication WO 96/08520 and U.S. Pat. No. 5,712,352, which are herein fully incorporated by reference.

In another preferred embodiment the one or all of the catalysts are combined with up to 10 weight % of a metal stearate, (preferably a aluminum stearate, more preferably aluminum distearate) based upon the weight of the catalyst, any support and the stearate, preferably 2 to 3 weight %. In an alternate embodiment a solution of the metal stearate is fed into the reactor. In another embodiment the metal stearate is mixed with the catalyst and fed into the reactor separately. These agents may be mixed with the catalyst or may be fed into the reactor in a solution with or without the catalyst system or its components.

In another preferred embodiment the catalysts combined with the activators are tumbled with 1 weight % of aluminum distearate or 2 weight % of an antistatic agent, such as a methoxylated amine, such as Witco's Kemamine AS-990 from ICI Specialties in Bloomington, Delaware.

More information on using aluminum stearate type additives may be found in U.S. Ser. No. 09/113,261, filed Jul. 10, 1998, which is incorporated by reference herein.

Preferred catalysts prepared by contacting the catalyst precursors and activators as described herein offer substantial improvements in catalyst activity over conventional catalysts. For example, replacement of a single benzyl ligand with an alkoxy or aryloxy group in complexes 1a, 2a, and 3a resulted in activity enhancements of between two- and 16-fold and even greater. Higher activity catalysts are advantageous in that they facilitate high-throughput in process equipment allowing for a reduction in total cost associated with the production of a polymer product. In addition, high activity catalysts which generate polymers with low catalyst residues may offer an advantage of lower requirements for post production additives which can also contribute to manufacturing costs. Still further, lower catalyst residues can improve the performance of polymer products, especially with regard to optical properties manifested in the products derived therefrom. Examples of products benefitting from enhanced processibility, strength and optical properties include, but are not limited to, mono-, bi-, and polymodal-resins for use in formulating injection and blow-molded materials, stretch films and other films used in wrappings and packagings.

In a preferred embodiment the polymer produced herein has an I₂₁ (as measured by ASTM 1238, condition E, at 190° C.) of 3000 or less dg/min, preferably 1000 or less, more preferably between 0.001 and 1000 dg/min.

In a preferred embodiment, the polyolefin recovered is ethylene homopolymer or copolymer. In a preferred embodiment for certain applications, such as films, molded article and the like a melt index of 100 g/10 min or less is preferred. For some films and molded article a melt index of 10 g/10 min or less is preferred.

In a preferred embodiment the catalyst system described above is used to make a polyethylene having a density of between 0.88 and 0.970 glcm³ (as measured by ASTM 2839) In some embodiments, a density of 0.915 to 0.940g/cm³ would be preferred, in other embodiments densities of 0.930 to 0.960g/cm³ are preferred.

The polyolefins then can be made into films, molded articles, sheets, wire and cable coating and the like. The films may be formed by any of the conventional techniques known in the art including extrusion, co-extrusion, lamination, blowing and casting. The fllm may be obtained by the flat film or tubular process which may be followed by orientation in an uniaxial direction or in two mutually perpendicular directions in the plane of the film to the same or different extents. Orientation may be to the same extent in both directions or may be to different extents. Particularly preferred methods to form the polymers into films include extrusion or coextrusion on a blown or cast film line.

The films produced may further contain additives such as slip, antiblock, antioxidants, pigments, fillers, antifog, UV stabilizers, antistats, polymer processing aids, neutralizers, lubricants, surfactants, pigments, dyes and nucleating agents. Preferred additives include silicon dioxide, synthetic silica, titanium dioxide, polydimethylsiloxane, calcium carbonate, metal stearates, calcium stearate, zinc stearate, talc, BaSO₄, diatomaceous earth, wax, carbon black, flame retarding additives, low molecular weight resins, hydrocarbon resins, glass beads and the like. The additives may be present in the typically effective amounts well known in the art, such as 0.001 weight % to 10 weight %.

The following examples further illustrate the invention.

### EXAMPLES

The following catalyst precursors and activators were used in examples 1-12:

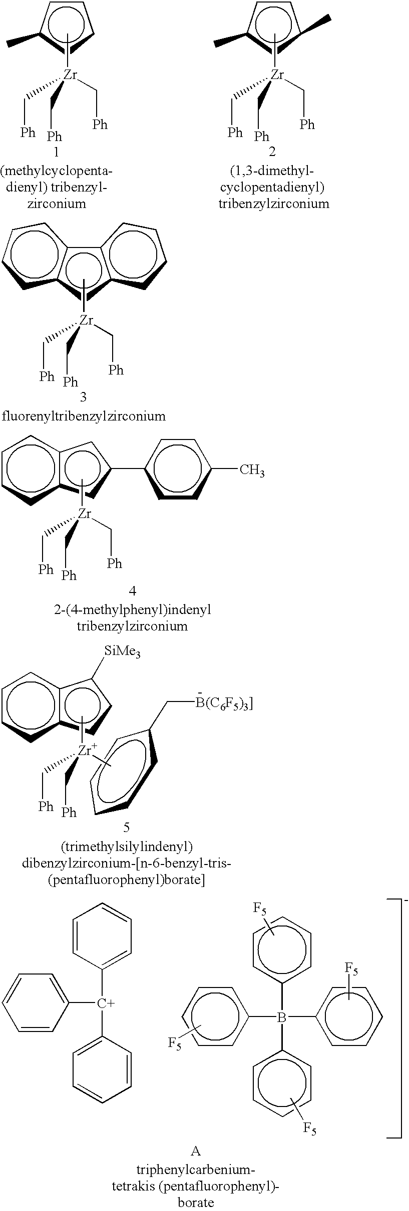

Tetrabenzylzirconium was purchased from Boulder Scientific and was purified by Soxhlet extraction with pentane/ether prior to use.

Triphenylcarbenium tetrakis (pentafluorophenyl)borate (A), N,N-dimethylanilinium tetrakis (pentafluorophenyl)borate and tris(pentafluorophenyl)borane (C) were purchased from Boulder Scientific and Akzo Nobel. Tri-n-hexylammonium tetrakis(pentafluorophenyl)borate (B) was prepared by reaction of tri-n-hexylamine with N,N-dimethylanilinium tetrakis (pentafluorophenyl)borate.

Modified methylalumoxane was obtained from Akzo Nobel.

All solvents were purified by successive passage through a bed of activated alumina and supported copper chromite deoxo catalyst.

Tribenzylzirconium-η⁶-(tetraphenylborate) was prepared by the method of Bochmann et al.(J. Chem. Soc., Chem. Comm., 1990, 1038-1039).

Tribenzylzirconium-η⁶-(benzyl-tris(pentafluorophenyl)borate) was prepared according to the procedure of Pellecehia et al. (J. Mol. Catal. 82, 1993, 57-65).

Preparation of (Methylcyclopentadienyl)tribenzylzirconium (1) and (1,3-dimethylcyclopentadienyl)tribenzylzirconium (2)

Tetrabenzylzirconium (15 g, 33 mmol) and methylcyclopentadienyllithium (2.37 g, 28 mmol) were dissolved in toluene (200 mL) at ambient temperature. After stirring for 5 hours, chlorotrimethylsilane (3.57 g, 4.17 mL, 33 mmol) was added via syringe and the stirred solution was maintained at ambient temperature overnight. After filtration through Celite, the volatile materials were removed in vacuo and the residue was recrystallized from toluene/hexane at −35° C. to afford 9.65 g of pure 1 in 78% yield from the first crop.

(1,3-dimethylcyclopentadienyl)tribenzylzirconium (2) was prepared analogously.

Preparation of Fluorenyltribenzylzirconium (3) and 2-(4-Methylphenyl)indenyltribenzylzirconium

Tribenzylzirconium-η⁶-(tetraphenylborate) (200 mg, 0.29 mmol) and fluorenylpotassium (59 mg, 0.29 mmol) were suspended in a solution of toluene (10 mL) and tetrahydrofuran )(1 mL) and were stirred for 2 hours at ambient temperature. After filtration through a Celite pad, the filtrate was pumped to dryness and the residue was recrystallized from toluene/hexane at −30° C. to afford 73 mg (0.14 mmol) of fluorenyltribenzylzirconium (3) as a bright yellow crystalline solid.

2-(4-Methylphenyl)indenyltribenzylzirconium (4) was prepared analogously.

Preparation of (1-trimethylsilylindenyl)tribenzylzirconium (5)

Tribenzylzirconium-η⁶-(benzyl-tris(pentafluorophenyl)borate) (895 mg, 0.92 mmol) and l-trimethylsilylindene (173.8 mg, 0.92 mmol) were dissolved in toluene (19 ml) and stirred at ambient temperature overnight. The product was filtered on a glass frit, washed with toluene and dried in vacuo to give (1-trimethylsilylindenyl)tribenzylzirconium (5) as a bright yellow crystalline solid.

### Example 1

### Slurry-Phase Ethylene-1-Hexene Copolymerization by (MeCp)Zr(CH₂Ph)₃/Triphenylearbenium tetrakis(pentafluorophenyl)borate

Into a 1 L stirred autoclave reactor under a nitrogen purge and maintained at temperature of 55° C. was placed 600 mL of dry hexane. 1-Hexene (43 mL) and triisobutylaluminum (100 μL of 1 M solution in hexane, 100 μmol) were added via syringe. After stirring for approximately 10 minutes, the reactor was pressurized to 85 p.s.i with ethylene.

A catalyst solution was prepared by dissolving a solid mixture of (MeCp)Zr(CH₂Ph)₃ (1) (5.0 mg, 11.3 μmol) and triphenylcarbenium tetrakis(pentafluorophenyl)borate (A)(10.4 mg, 11.3 μmol, 1 equiv) in a solution of triisobutylaluminum (10.2 mg, 13 μL, 52 μmol, 4.6 equiv) in toluene (10 mL). The polymerization was carried out by injecting the activated catalyst solution into the reactor at 55° C. with rapid ramping of the temperature of the reactor to a set temperature of 75° C. after an initial exotherm and with maintenance of the set temperature and pressure for a period of 30 minutes. Polymerization activities were calculated as g polymer (mmol Zr )⁻¹ (h)⁻¹ (100 p.s.i.ethylene)⁻¹.

The results are shown in Table 1 below.

### Example 2

### Slurry-Phase Ethylene-1-Hexene Copolymerization by (1,3-Me₂Cp)Zr(CH₂Ph)₃/Triphenylcarbenium tetrakis(pentafluorophenyl)borate

Example 2 was carried out in the same manner as Example 1, except that the catalyst composition was prepared by dissolving a solid mixture of (1,3-Me₂Cp)Zr(CH₂Ph)₃ (2) (5.0 mg, 10.8 μmol) and triphenylcarbenium telrakis(pentafluorophenyl)borate (A)(10.0 mg, 10.8 μmol, 1 equiv) in a solution of triisobutylaluminum (10.2 mg, 13 μL, 52 μmol, 4.8 equiv) in toluene (20 mL).

The results are shown in Table 1 below.

### Example 3

### Slurry-Phase Ethylene-1-Hexene Copolymerization by (Fluorenyl)Zr(CH₂Ph)₃/Triphenylcarbenium tetrakis(pentafluorophenyl)borate

Example 3 was carried out in the same manner as Example 1, except that the catalyst composition was prepared by dissolving a solid mixture of (fluorenyl)Zr(CH₂Ph)₃ (3) (6.0 mg, 11.3 μmol) and triphenylcarbenium tetrakis(pentafluorophenyl)borate (A) (10.4 mg, 11.3 μmol, 1 equiv) in a solution of triisobutylaluminum (10.2 mg, 13 μL, 52 μmol, 4.6 equiv) in toluene (5 mL).

The results are shown in Table 1 below.

### Example 4

### Slurry-Phase Ethylene-1-Hexene Copolymerization by 2-(p-Tolylindenyl)Zr(CH₂Ph)₃/Triphenylcarbenium tetrakis(pentafluorophenyl)borate

Example 4 was carried out in the same manner as Example 1, except that the catalyst composition was prepared by dissolving a solid mixture of 2-(p-tolylindenyl)Zr(CH₂Ph)₃ (4) (5.0 mg, 8.8 μmol) and triphenylcarbenium tetrakis(pentafluorophenyl)borate (A) (9.24 mg, 10.0 μmol, 1.1 equiv) in a solution of triisobutylaluminum (10.2 mg, 13 μL, 52 μmol, 4.6 equiv) in toluene (10 mL).

The results are shown in Table 1 below.

### Example 5

### Slurry-Phase Ethylene-1-Hexene Copolymerization by (1-Trimethylsilylindenyl)Zr(CH₂Ph)₂-(η⁶_(PhCH₂B(C₆F₅)₃))Triphenylcarbenium tetrakis(pentafluorophenyl)borate

Example 5 was carried out in the same manner as Example 1, except that the catalyst composition was prepared by dissolving a solid mixture of (1-trimethylsilylindenyl)Zr(CH₂Ph)₂-(η⁶_(PhCH₂B(C₆F₅)₃))(5) (10.0 mg, 8.7 μmol) and triphenylcarbenium tetrakis(pentafluorophenyl)borate (A)(9.2 mg, 10.0 μmol, 1.15 equiv) in a solution of triisobutylaluminum (10.2 mg, 13 μL, 52 μmol, 6.0 equiv) in toluene (5 mL).

The results are shown in Table 1 below.

### Example 6

### Slurry-Phase Ethylene-1-Hexene Copolymerization by (MeCp)Zr(CH₂Ph)₃/Triphenylcarbenium tetrakis(pentafluorophenyl)borate at Substoichiometric Activator Ratios

Example 6 was carried out in the same manner as Example 1, except that the catalyst composition was prepared using 0.75 equivalents of triphenylcarbenium tetrakis(pentafluorophenyl)borate (A).

The results are shown in Table 2 below.

### Example 7

### Slurry-Phase Ethylene-1-Hexene Copolymerization by (MeCp)Zr(CH₂Ph)₃/Triphenylcarbenium tetrakis(pentafluorophenyl)borate at Substoichiometric Activator Ratios

Example 7 was carried out in the same manner as Example 1, except that the catalyst solution was prepared using 0.50 equivalents of triphenylcarbenium tetrakis(pentafluorophenyl)borate (A).

The results are shown in Table 2

### Example 8

### Slurry-Phase Ethylene-1-Hexene Copolymerization by (MeCp)Zr(CH₂Ph)₃/Modified Methylalumoxane

Example 8 was carried out in the same manner as Example 1, except that the catalyst composition was prepared by dissolving (MeCp)Zr(CH₂Ph)₃ (1) (5.0 mg, 11.3 μmol) in a 3 mL of a 17 wt % solution of 1-hexene in hexane and reacting this solution with modified methylalumoxane (2 mL of 1.68 M solution in heptane, 3.36 mmol Al, 297 equiv).

The results are shown in Table 2 below.

### Example 9

### Slurry-Phase Ethylene-1-Hexene Copolymerization by (MeCp)Zr(CH₂Ph)₃/Tris(pentafluorophenyl)borane

Example 9 was carried out in the same manner as Example 1, except that the catalyst composition was prepared by dissolving a solid mixture of (MeCp)Zr(CH₂Ph)₃ (1) (5.0 mg, 11.3 μmol) and tris(pentafluorophenyl)borane (C)(11.6 mg, 22.7 μmol, 2.0 equiv) in toluene (5 mL).

The results are shown in Table 2 below.

### Example 10

### Slurry-Phase Ethylene-1-Hexene Copolymerization by (MeCp)Zr(CH₂Ph)₃/Tris(pentafluorophenyl)borane

Example 10 was carried out in the same manner as Example 9, except that the catalyst composition was prepared using 1.5 equivalents of tris(pentafluorophenyl)borane (C).

The results are shown in Table 2 below.

### Example 11

### Slurry-Phase Ethylene-1-Hexene Copolymerization by (MeCp)Zr(CH₂Ph)₃/Tris(pentafluorophenyl)borane

Example 11 was carried out in the same manner as Example 9, except that the catalyst composition was prepared by using 2.0 equivalents of tris(pentafluorophenyl)borane (C).

The results are shown in Table 2.

### Example 12

### Slurry-Phase Ethylene-1-Hexene Copolymerization by (1,3-Me₂Cp)Zr(CH₂Ph)₃/Trihexylammonium tetrakis(pentafluorophenyl)borate

Example 12 was carried out in the same manner as Example 1 except that the catalyst composition was prepared by dissolving a solid mixture of (1,3-Me₂Cp)Zr(CH₂Ph)₃ (2) (5.0 mg, 10.8 μmol) and trihexylammonium tetrakis(pentafluorophenyl)borate (B)(10.3 mg, 10.8 μmol, 1 equiv) in toluene (10 mL).

The results are shown in Table 2 below.

TABLE 1

| Example | Catalyst | μmol catalyst | polymer yield (g) | activity* |
|---|---|---|---|---|
| 1 | 1 | 0.22 | 90.5 | 949355 |
| 2 | 2 | 0.27 | 71.9 | 621196 |
| 3 | 3 | 0.22 | 24.3 | 254483 |
| 4 | 4 | 0.18 | 4.2 | 55442 |
| 5 | 5 | 0.22 | 14.1 | 153595 |

*activity reported in units of g PE (mmolZr)⁻¹ (h)⁻¹ (100 psi ethylene)⁻¹

TABLE 2

| Ex- | Cata- | | Activator/ | μmol | polymer | |
|---|---|---|---|---|---|---|
| ample | lyst | Activator | catalyst | catalyst | yield (g) | activity* |
| 6 | 1 | A | 0.75 | 0.22 | 3.5 | 36699 |
| 7 | 1 | A | 0.5 | 1.1 | 3.7 | 7759 |
| 8** | 1 | MMAO | 300 | 1 | 4.0 | 9412 |
| 9** | 1 | C | 1.5 | 0.22 | 0 | 0 |
| 10** | 1 | C | 1.5 | 1.1 | 0 | 0 |
| 11** | 1 | C | 2 | 1.1 | 1.2 | 2472 |
| 12 | 2 | B | 1 | 0.53 | 67.4 | 291159 |

*activity reported in units of g PE (mmolZr)⁻¹ (h)⁻¹ (100 psi ethylene)⁻¹
**comparative

### Example 13

### Preparation of Alkyl- and Aryloxy -Substituted Half-Sandwich Dibenzyl Complexes.

Catalyst 1a is methycyclopentadienyl tribenzyl zirconium.

Catalyst 1b is methycyclopentadienyl phenoxy dibenzyl zirconium.

Catalyst 1c is methycyclopentadienyl (2,6 dimethylphenoxy) dibenzyl zirconium.

Catalyst 1d is methycyclopentadienyl (2,5 di-t-butyl phenoxy).dibenzyl zirconium.

Catalyst 2a is 1,3-dimethycyclopentadienyl tribenzyl zirconium.

Catalyst 2b is 1,3-dimethycyclopentadienyl phenoxy dibenzyl zirconium.

Catalyst 2c is 1,3-dimethycyclopentadienyl (2,6 dimethylphenoxy).dibenzyl zirconium.

Catalyst 2d is 1,3-dimethycyclopentadienyl (2,5 di-t-butyl phenoxy).dibenzyl zirconium.

Catalyst 3a is indenyl tribenzyl zirconium.

Catalyst 3b is indenyl phenoxy dibenzyl zirconium.

Catalyst 3c is indenyl (2,6 dimethylphenoxy).dibenzyl zirconium.

Catalyst 3d is indenyl (2,5 di-t-butyl phenoxy).dibenzyl zirconium.

Cyclopentadienyl- and Pentamethylcyclopentadienylzirconium Complexes

In a typical procedure, 250 μL of a 0.19 M solution of cyclopentadienyl tribenzyl zirconium or pentamethylcyclopentadienyl tribenzyl zirconium (46.6 μmol) in C₆D₆ was placed in a small vial. To the zirconium complex solution was added 750 μL of a 0.062 M solution of tert-butanol or phenol in C₆D₆. The solutions were mixed and transferred to a J. Young tube and were analyzed by ¹H NMR spectroscopy. The tubes were then subsequently analyzed after heating at 50° C. for 10 hours and for and additional heating period totaling 4 days. NMR measurements showed that the di- and trisubstituted products are the kinetic products but prolonged heating results in equilibration to generate an acceptable yield of the desired monosubstituted product.

Methylcyclopentadienyl-,1,3-Dimethylcyclopentadienyl and Indenylzirconium Aryloxide Complexes

Stock C₆D₆ solutions of methylcyclopentadienyl tribenzyl zirconium, 1,3-dimethylcyclopentadienyl tribenzyl zirconium and indenyl tribenzyl zirconium were prepared by dissolving the metal complex (1 mmol) in 3.0 mL of C₆D₆. In a typical procedure, 1.0 mL of stock metal complex solution (0.33 M) was placed in a small vial. To the solution was added one equiv (0.33 mmol) of phenol, 2,6-dimethylphenol or 2,5-di-tert-butylphenol. Each vial was capped, shaken to mix the contents and allowed to react at ambient temperature for a one week period. After one week, the contents of the vials were transferred to J. Young tubes and the reactions were analyzed by ¹H NMR spectroscopy. After NMR analysis, the tube contents were transferred to small vials and unreacted starting tribenzyl complex was precipitated from the reaction solution by pentane diffusion. The supernatants were decanted from the precipitated complex and dried in vacuo to give the partially purified reaction products. The products were again dissolved in C₆D₆ and analyzed a second time by ¹H NMR spectroscopy. After analysis, the solutions were returned to the glovebox and stored for subsequent polyolefin catalysis screening.

The catalysts were then used to polymerize ethylene according to the following general procedure:

General Polymerization Procedure.

Catalyst activation procedures for example 13 were performed in a glove box containing prepurified nitrogen. Polymerization experiments were performed in a one liter stainless steel reactor vessel. The following example is illustrative. In a typical procedure, a catalyst precursor stock solution was prepared by dissolving 220 micromoles of the desired transition metal complex in 10 mL of toluene to give a 0.0222 M solution. From this stock solution, a 0.20 mL aliquot was taken and placed in a vial. To the aliquot was added 0.62 mL of MMAO (250 equivalents). After an initial preheat of the reactor to 95° C. under a stream of dry nitrogen, the reactor is cooled to 60° C. and six hundred milliliters of hexane is charged to the reactor, followed successively by 1-hexene (43 ml, dried over 3× molecular sieves) and MMAO-3A, 250 equivalents based on catalyst precursor, d=0.73, 7.2 wt. % Al, 1.95 M, D051880/199). The reactor is then heated to 55° C. and the catalyst solution (0.19 mL, 1.00 micromole) is charged to the reactor via syringe. After the addition of the catalyst, the reactor is pressurized with ethylene to 107 psi (85 psi partial pressure for ethylene) (738 kPa, 586 kPa for ethylene partial pressure) and fed at a rate to maintain the initial pressure. Total reaction run times are 30 minutes.

Example 1a—The procedure above was followed except that catalyst 1a was used.

Example 1b—The procedure above was followed except that catalyst 1b was used.

Example 1c—The procedure above was followed except that catalyst 1c was used.

Example 1d—The procedure above was followed except that catalyst 1d was used.

Example 2a—The procedure above was followed except that catalyst 2a was used.

Example 2b—The procedure above was followed except that catalyst 2b was used.

Example 2c—The procedure above was followed except that catalyst 2c was used.

Example 2d—The procedure above was followed except that catalyst 2d was used.

Example 3a—The procedure above was followed except that catalyst 3a was used.

Example 3b—The procedure above was followed except that catalyst 3b was used.

Example 3c—The procedure above was followed except that catalyst 3c was used.

Example 3d—The procedure above was followed except that catalyst 3d was used.

The data are summarized in Table 3.

TABLE 3

| | Activity | | | Melt | Butyl Branching |
|---|---|---|---|---|---|
| | (g/mmol | I₂ | I₂₁ | Flow | Frequency |
| Ex. | Zr/hr/100 psi) | (dg/min) | (dg/min) | Ratio | (per 1000 C's) |
| 1a | 10224 | NF | 0.49 | NF | 2.88 |
| 1b | 20235 | 1.98 | 0.76 | 28.1 | 5.88 |
| 1c | 28471 | 8.78 | 0.51 | 29.5 | 5.34 |
| 1d | 8908 | 0.87 | 0.62 | 31.4 | 7.73 |
| 2a | 11295 | NF | NF | NF | 6.07 |
| 2b | 29063 | 2.57 | 0.11 | NF | 6.17 |
| 2c | 4694 | 0.42 | 0.12 | NF | 4.48 |
| 2d | 9659 | 0.86 | 0.13 | NF | 6.73 |
| 3a | 15442 | NF | 1.31 | 22.1 | 8.71 |
| 3b | 36200 | 2.34 | 2.44 | 27.3 | 10.12 |
| 3c | 254729 | 16.5 | 3.48 | 17.8 | 9.82 |
| 3d | 76318 | 4.94 | 4.04 | 22.6 | 10.69 |

NF = no flow

Melt Index (MI) I₂ and I₂₁, were measured according to ASTM D-1238, Condition E, at 190° C.

Melt Flow Ratio (MFR) is the ratio of I₂₁ over I₂ as determined by ASTM D-1238.

Butyl Branching Frequency was measured according to the procedure described in EP 776 980 A1.

All documents described herein are incorporated by reference herein, including any priority documents and/or testing procedures. As is apparent form the foregoing general description and the specific embodiments, while forms of the invention have been illustrated and described, various modifications can be made without departing from the spirit and scope of the invention. Accordingly it is not intended that the invention be limited thereby.

1. A catalyst composition for the polymerization of olefins comprising:
a) a catalyst precursor of the formula LMⁿ⁺(X)_{y}(R)_{(n-y-1)}, wherein L is a cycloalkadienyl ligand except for cyclopentadienyl and pentamethylcyclopentadienyl; M is an element selected from Groups 3 to 10 and the Lanthanides; each X is an anion; each R is a hydride or a group containing at least two carbons capable of attachment to M in a multihapto manner through at least one hydrogen or carbon atom; n is the valence of M; and y is an integer from 0 to 5.
b) a cocatalyst capable of irreversibly abstracting an X or an R from the catalyst precursor such that at least one metal-carbon or metal-hydrogen bond is retained in the resulting activated catalyst.

2. The catalyst composition of claim 1, wherein the catalyst precursor has the formula:
LMⁿ⁺(CH₂Ph)ₙ₋₁
wherein L is a cycloalkadienyl ligand except for cyclopentadienyl and pentamethylcyclopentadienyl; M is an element selected from Groups 3 to 10 and the Lanthanides; n is the valence of M; y is an integer from 0 to 5; and Ph is phenyl.

3. The catalyst composition of claim 1, wherein the catalyst precursor has a formula selected from the group consisting of:

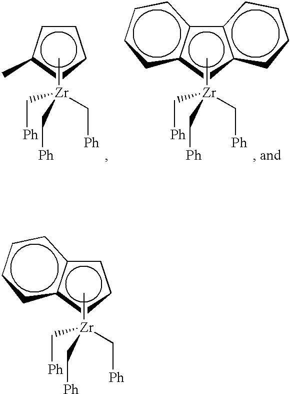

4. The catalyst composition of claim 1, wherein the cocatalyst is a borate of the formula BR″₄_{⁻}, wherein R″ is selected from the group consisting of perfluoroaryl, perfluoroalkyl, and perfluoroalkyl-substituted moieties.

5. The catalyst composition of claim 1, wherein the cocatalyst is triphenylcarbenium tetrakis (pentafluorophenyl)borate.

6. The catalyst composition of claim 1 in liquid form.

7. The catalyst composition of claim 1 further comprising an inert support.

8. A composition comprising an activator and a catalyst precursor represented by the formula:
CpD^{a}(JY)(Q)_{(a-2),}
wherein:
Cp is a substituted or unsubstituted cycloalkadienyl group or related cycloalkadienyl cogener,
each Q is independently an anionic leaving group,
J is a group 15, 16 or 17 atom;
a is the oxidation state of D,
D is a group 4, 5 or 6 metal, provided however that when Cp is a mono-cyclic cyclopentadienyl group M is not titanium, and
Y is a heteroatom, a substituted heteroatom or a C₁ to C₁₀₀ hydrocarbyl group which may optionally contain one or more heteroatoms.

9. The composition of claim 8 wherein Cp is a cyclopentadienyl group.

10. The composition of claim 8 wherein Cp is an indenyl or fluorenyl group.

11. The composition of claim 8 wherein Cp is substituted.

12. The composition of claim 10 wherein the indene or fluorene is substituted.

13. The composition of claim 8 wherein D is a group four metal.

14. The composition of claim 8 wherein D is zirconium or hafnium.

15. The composition of claim 8 wherein Y is a substituted or unsubstituted group 13-17 heteroatom or a C₁ to C₄₀ alkyl, alknyl, aryl, or arylalkyl group.

16. The composition of claim 9 wherein Y is an alkyl group, a perfluoroalkyl group, a cycloalkyl group or an aryl group.

17. The composition of claim 9 wherein Y is selected from the group consisting of n-propyl, isopropyl, n-butyl, t-butyl, methylcyclohexyl, methylcyclopentyl, methoxymethyl, ethoxymethyl, aminomethyl, aminoethyl, perfluoropropyl, and perfluorobutyl, cyclopentyl, cychexyl, bicyclo[2.2.1]heptyl, phenyl, methyl phenyl, di methyl phenyl, di n-butylphenyl, di-t-butylphenyl, mesityl, 4-trimethylsilyl, fluorophenyl, perfluorophenyl, methoxyphenyl, dimethylaminophenyl, naphthyl, and anthracenyl.

18. The composition of claim 8 wherein J is nitrogen, oxygen, sulfur, phosphorus, chlorine, fluorine or bromine,

19. The composition of claim 8 wherein J is oxygen, nitrogen or sulfur.

20. The composition of claim 8 wherein J is oxygen.

21. The composition of claim 8 wherein Cp is an indenyl group, J is oxygen and Y is a substituted or unsubstituted phenyl group.

22. A process for polymerizing olefin(s) comprising contacting one or more olefin(s) under polymerization conditions with a catalyst composition comprising:
a) a catalyst precursor of the formula LMⁿ⁺(X)_{y}(R)_{(n-y-1)}, wherein L is a cycloalkadienyl ligand except for cyclopentadienyl and pentamethylcyclopentadienyl; M is an element selected from Groups 3 to 10 and the Lanthanides; each X is an anion; each R is a hydride or a group containing at least two carbons capable of attachment to M in a multihapto manner through at least one hydrogen or carbon atom; n is the valence of M; and y is an integer from 0 to 5; and
b) a cocatalyst capable of irreversibly abstracting an X or an R from the catalyst precursor such that at least one metal-carbon or metal-hydrogen bond is retained in the resulting activated catalyst.

23. A process for polymerizing olefin(s) comprising contacting one or more olefin(s) under polymerization conditions with a catalyst composition comprising a catalyst precursor represented by the formula:
CpD^{a}(JY)(Q)₍ₐ₋₂₎,
wherein:
Cp is a substituted or unsubstituted cycloalkadienyl group or related cycloalkadienyl cogener,
each Q is independently an anionic leaving group,
J is a group 15, 16 or 17 atom;
a is the oxidation state of D,
D is a group 4, 5 or 6 metal, provided however that when Cp is a mono-cyclic
cyclopentadienyl group M is not titanium, and
Y is a heteroatom, a substituted heteroatom or a C₁ to C₁₀₀ hydrocarbyl group which may optionally contain one or more heteroatoms.
